(19) United States
(12) Patent Application Publication
(10) Pub. No.: US 2016/0216656 A1
(43) Pub. Date: Jul. 28, 2016

(54) IMAGE FORMING APPARATUS

(71) Applicant: FUNAI ELECTRIC CO., LTD., Daito-shi, Osaka (JP)

(72) Inventor: Masami SHIRATORI, Moriguchi-shi (JP)

(21) Appl. No.: 14/916,635

(22) PCT Filed: May 29, 2014
(86) PCT No.: PCT/JP2014/064236

§ 371 Date: Mar. 4, 2016

(30) Foreign Application Priority Data
Sep. 5, 2013 (JP) 2013-183628

(51) Int. Cl. B41J 2/385

(52) U.S. Cl. CPC G03G 15/2007

(57) ABSTRACT

This image forming apparatus (100) includes a housing portion (12), an image carrier (70) mounted on the housing portion, a light source portion (79) that applies light to the image carrier, and a light source fixing member in which a first restriction portion (132), a second restriction portion (133), and a third restriction portion (134) that restrict the movement of the light source portion in a first direction, a second direction, and a third direction, respectively, with respect to the housing portion are integrally provided, that fixes the light source portion to the housing portion.

### TECHNICAL FIELD

The present invention relates to an image forming apparatus, and more particularly, it relates to an image forming apparatus including a light source portion that applies light to an image carrier.

### BACKGROUND ART

An image forming apparatus including a light source portion that applies light to an image carrier is known in general. Such an image forming apparatus is disclosed in Japanese Patent Laying-Open No. 2010-221510, for example.

In the aforementioned Japanese Patent Laying-Open No. 2010-221510, there is disclosed an image forming apparatus including a housing, a photoreceptor drum (image carrier) mounted on the housing to be rotatable using a first direction as a rotation axis, an LED print head (light source portion) that is arranged to extend along the first direction and applies light to the photoreceptor drum, a first spring member that restricts the movement of the LED print head in the first direction and a second direction intersecting with the first direction with respect to the housing, and a second spring member that is provided separately from the first spring member and restricts the movement of the LED print head in a third direction intersecting with each of the first direction and the second direction with respect to the housing.

### PRIOR ART

### Patent Document

Patent Document 1: Japanese Patent Laying-Open No. 2010-221510

### SUMMARY OF THE INVENTION

### Problem to be Solved by the Invention

In the image forming apparatus described in the aforementioned Japanese Patent Laying-Open No. 2010-221510, however, the first spring member that restricts the movement of the LED print head in the first direction and the second direction intersecting with the first direction with respect to the housing and the second spring member that restricts the movement of the LED print head in the third direction intersecting with each of the first direction and the second direction with respect to the housing are provided separately, and hence there is such a problem that the number of components is increased.

The present invention has been proposed in order to solve the aforementioned problem, and one object of the present invention is to provide an image forming apparatus capable of reducing the number of components configured to fix a light source portion that applies light to an image carrier.

### Means for Solving the Problem

An image forming apparatus according to an aspect of the present invention includes a housing portion, an image carrier mounted on the housing portion to be rotatable using a first direction as a rotation axis, a light source portion that is arranged to extend along the first direction and applies light to the image carrier, and a light source fixing member in which a first restriction portion that restricts the movement of the light source portion in the first direction with respect to the housing portion, a second restriction portion that restricts the movement of the light source portion in a second direction intersecting with the first direction with respect to the housing portion, and a third restriction portion that restricts the movement of the light source portion in a third direction intersecting with each of the first direction and the second direction with respect to the housing portion are integrally provided, that fixes the light source portion to the housing portion in the vicinity of at least one end of the light source portion in the first direction.

As hereinabove described, the image forming apparatus according to this aspect of the present invention includes the light source fixing member in which the first restriction portion that restricts the movement of the light source portion in the first direction with respect to the housing portion, the second restriction portion that restricts the movement of the light source portion in the second direction intersecting with the first direction with respect to the housing portion, and the third restriction portion that restricts the movement of the light source portion in the third direction intersecting with each of the first direction and the second direction with respect to the housing portion are integrally provided, whereby the number of components configured to fix the light source portion that applies light to the image carrier can be reduced as compared with the case where the first restriction portion that restricts the movement in the first direction, the second restriction portion that restricts the movement in the second direction, and the third restriction portion that restricts the movement in the third direction are provided separately. Furthermore, the number of assembly steps can be reduced as compared with the case where the first restriction portion, the second restriction portion, and the third restriction portion are sequentially mounted.

Preferably in the aforementioned image forming apparatus according to this aspect, the light source fixing member urges the light source portion from one end side toward the other end side in the first direction by the first restriction portion and urges the light source portion toward the image carrier in the second direction by the second restriction portion. According to this structure, the position of the light source portion to be fixed can be reliably defined with respect to the image carrier in the first direction, which is the rotation axis direction of the image carrier, and the position of the light source portion to be fixed can be reliably defined with respect to the image carrier in the second direction, which is a direction in which the image carrier and the light source portion are away from each other.

Preferably in the aforementioned image forming apparatus according to this aspect, the first direction, the second direction, and the third direction substantially orthogonally intersect with each other. According to this structure, the first restriction portion, the second restriction portion, and the third restriction portion restrict the movement of the light source portion in the first direction, the second direction, and the third direction, respectively, such that the light source portion can be fixed in a balanced manner.

Preferably, the aforementioned image forming apparatus according to this aspect preferably further includes a first engagement portion arranged on the other end side of the light source portion in the first direction, and the first engagement portion engages with a second engagement portion of the housing portion to define the position of the light source portion in the first direction. According to this structure, after the first engagement portion engages with the second engagement portion on the other end side of the light source portion in the first direction to define the position of the light source portion in the first direction, the movement of the light source portion in the first direction, the second direction, and the third direction is restricted on one end side of the light source portion in the first direction such that the light source portion can be fixed to the housing portion.

Preferably in the aforementioned structure including the first engagement portion, the first engagement portion includes a tapered portion having a diameter reduced toward an end, and the tapered portion comes into contact with the second engagement portion to define the position of the light source portion in the first direction. According to this structure, the tapered portion of the first engagement portion can come into contact with and be fitted into the second engagement portion, and hence an engagement gap between the first engagement portion and the second engagement portion can be eliminated. Thus, backlash can be eliminated.

Preferably in the aforementioned structure including the first engagement portion, an end of the first engagement portion comes into contact with a bottom portion of the second engagement portion, which is concave, of the housing portion to define the position of the light source portion. According to this structure, the end of the first engagement portion comes into contact with the bottom portion of the concave second engagement portion, and hence the position of the light source portion in the first direction can be accurately defined.

Preferably, the aforementioned structure including the first engagement portion further includes an urging portion that is arranged on the other end side of the light source portion in the first direction and urges the light source portion toward the image carrier. According to this structure, the movement of the light source portion in the first direction, the second direction, and the third direction is restricted on one end side of the light source portion in the first direction while the light source portion is urged toward the image carrier on the other end side of the light source portion in the first direction, and the light source portion can be reliably fixed while the position of the light source portion is accurately defined with respect to the housing portion.

Preferably in the aforementioned image forming apparatus according to this aspect, the light source fixing member is fixed to the housing portion by a fastening member. According to this structure, the light source fixing member can be reliably fixed to the housing portion by the fastening member, and hence the light source portion can be easily fixed to the housing portion through the light source fixing member.

Preferably in the aforementioned image forming apparatus according to this aspect, the light source fixing member includes a leaf spring. According to this structure, the movement of the light source portion in the first direction, the second direction, and the third direction is restricted by the single leaf spring such that the light source portion can be easily fixed to the housing portion.

Preferably in the aforementioned image forming apparatus according to this aspect, the light source portion includes a plurality of LEDs arrayed along the first direction. According to this structure, using the LEDs as a light source, the life of the light source portion can be extended, and energy consumed by the light source portion can be saved.

Preferably in the aforementioned image forming apparatus according to this aspect, the light source portion includes a fixation portion arranged in one end in the first direction, fixed to the housing portion by the light source fixing member. According to this structure, the light source portion can be reliably fixed to the housing portion by the fixation portion and the light source fixing member.

Preferably in this case, the light source portion further includes a body portion in which a light source is arranged and a first engagement portion that is arranged on the other end side of the light source portion and defines the position of the light source portion in the first direction, and the body portion, the first engagement portion, and the fixation portion are integrally provided. According to this structure, the number of components can be reduced as compared with the case where the body portion, the first engagement portion, and the fixation portion are formed separately.

Preferably in the aforementioned structure in which the body portion, the first engagement portion, and the fixation portion are integrally provided, the fixation portion has a substantially U-shaped cross-section, and the first restriction portion of the light source fixing member comes into contact with one end surface of the body portion and urges the light source portion in the first direction inside the fixation portion, which is substantially U-shaped. According to this structure, the first restriction portion is inserted into the substantially U-shaped fixation portion and urges an end of the body portion, and hence the first restriction portion can urge the light source portion in the first direction without interfering with the second restriction portion and the third restriction portion.

Preferably in the aforementioned structure in which the fixation portion has the substantially U-shaped cross-section, the second restriction portion of the light source fixing member comes into contact with end surfaces of two sides of the fixation portion, which is substantially U-shaped, closer to an opening and urges the light source portion in the second direction. According to this structure, the second restriction portion can easily restrict the movement of the light source portion in the second direction with respect to the housing portion by urging the end surfaces of the two sides of the substantially U-shaped fixation portion closer to the opening in the second direction.

Preferably in the aforementioned structure in which the fixation portion has the substantially U-shaped cross-section, the third restriction portion of the light source fixing member comes into contact with the fixation portion, which is substantially U-shaped, from the outside and urges the light source portion in the third direction. According to this structure, the third restriction portion can easily restrict the movement of the light source portion in the third direction with respect to the housing portion by urging the light source portion in the third direction from the outside of the substantially U-shaped fixation portion.

Preferably in the aforementioned image forming apparatus according to this aspect, the first direction is the axis direction of the image carrier, the second direction is the radial direction of the image carrier, and the third direction is the circumferential direction of the image carrier. According to this structure, the light source portion can be easily positioned in a predetermined location in the axis direction, the radial direction, and the circumferential direction of the image carrier to be fixed to the housing portion. Preferably in the aforementioned image forming apparatus according to this aspect, the light source fixing member further includes a bent portion that is bent in a substantially U-shape as viewed in the first direction and is deflectable in the second direction. According to this structure, the second restriction portion can be urged in the second direction by restoring force resulting from the deflection of the bent portion, and hence the second restriction portion can easily urge the light source portion in the second direction.

Preferably in the aforementioned structure including the first engagement portion, the first engagement portion includes a protrusion portion that protrudes to the other end side in the first direction, the second engagement portion includes a concave engagement hole, and the protrusion portion of the first engagement portion is fitted into and engages with the engagement hole of the second engagement portion. According to this structure, the protrusion portion is fitted into and engages with the engagement hole on the other end side of the light source portion in the first direction to accurately define the position of the light source portion in the first direction.

Preferably in the aforementioned image forming apparatus according to this aspect, the light source fixing member is provided with a boss hole, and the position of the light source fixing member to be fixed to the housing portion is defined in a state where a boss is inserted into the boss hole. According to this structure, the light source fixing member can be fixed to the housing portion after the position of the light source fixing member is accurately defined by the boss.

Preferably, the aforementioned image forming apparatus according to this aspect further includes a paper supply portion that supplies paper to the image carrier and a toner supply portion that supplies toner to the image carrier. According to this structure, the number of components configured to fix the light source portion that applies light to the image carrier can be reduced in the image forming apparatus including the paper supply portion and the toner supply portion.

### Effect of the Invention

According to the present invention, as hereinabove described, the image forming apparatus capable of reducing the number of components configured to fix the light source portion that applies light to the image carrier can be provided.

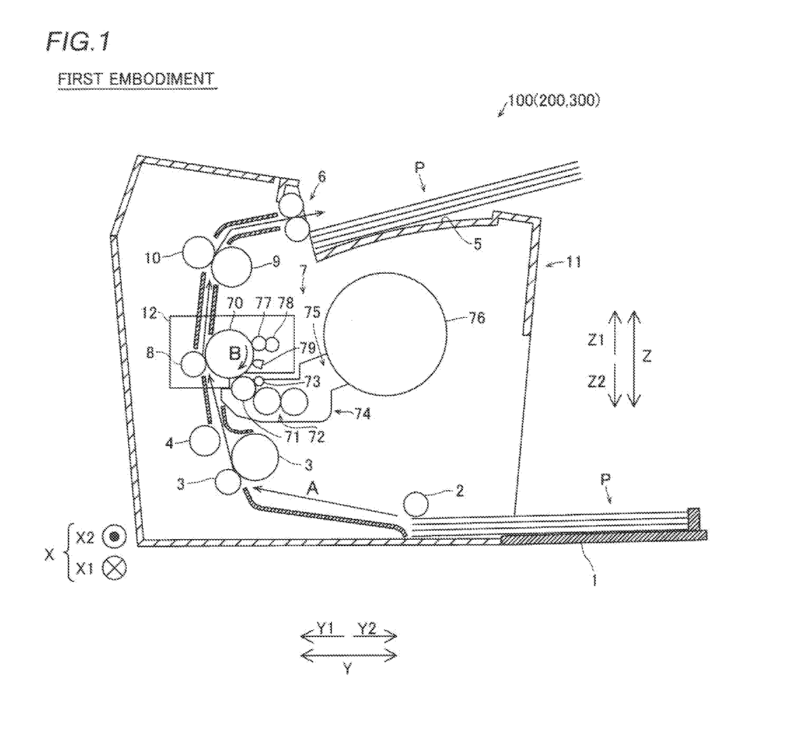

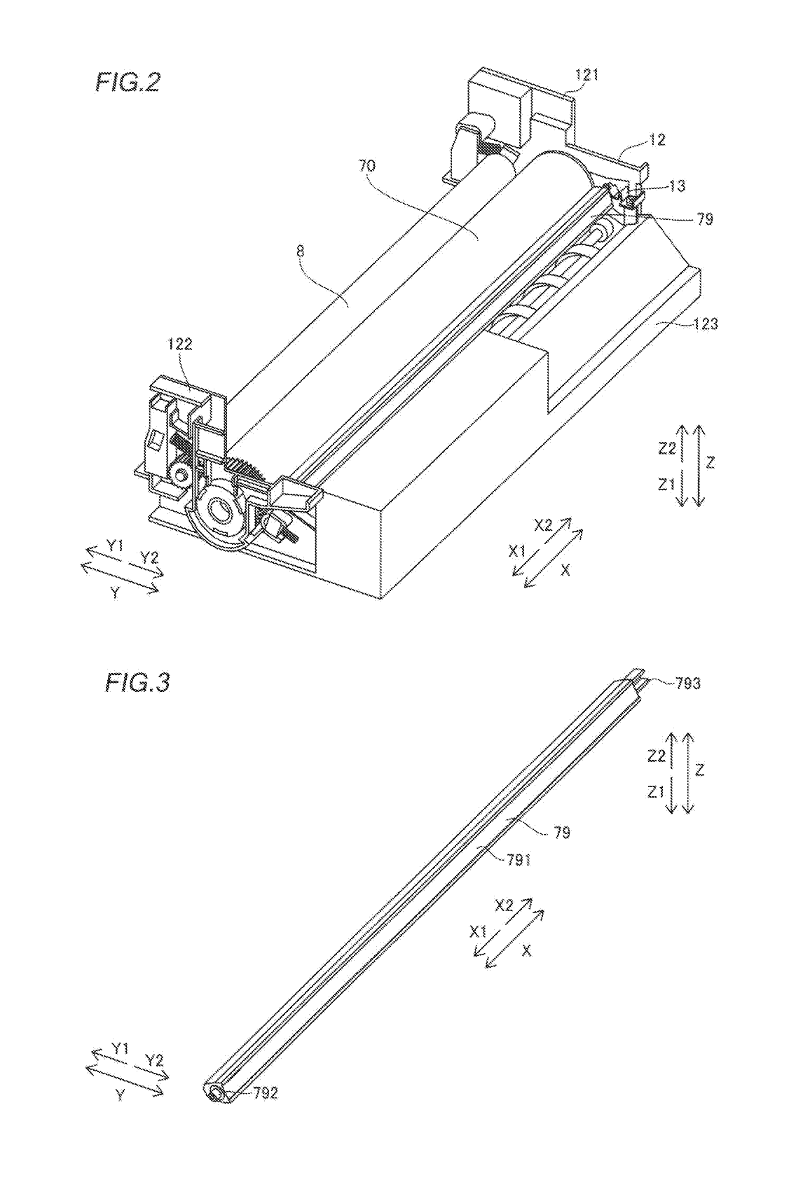

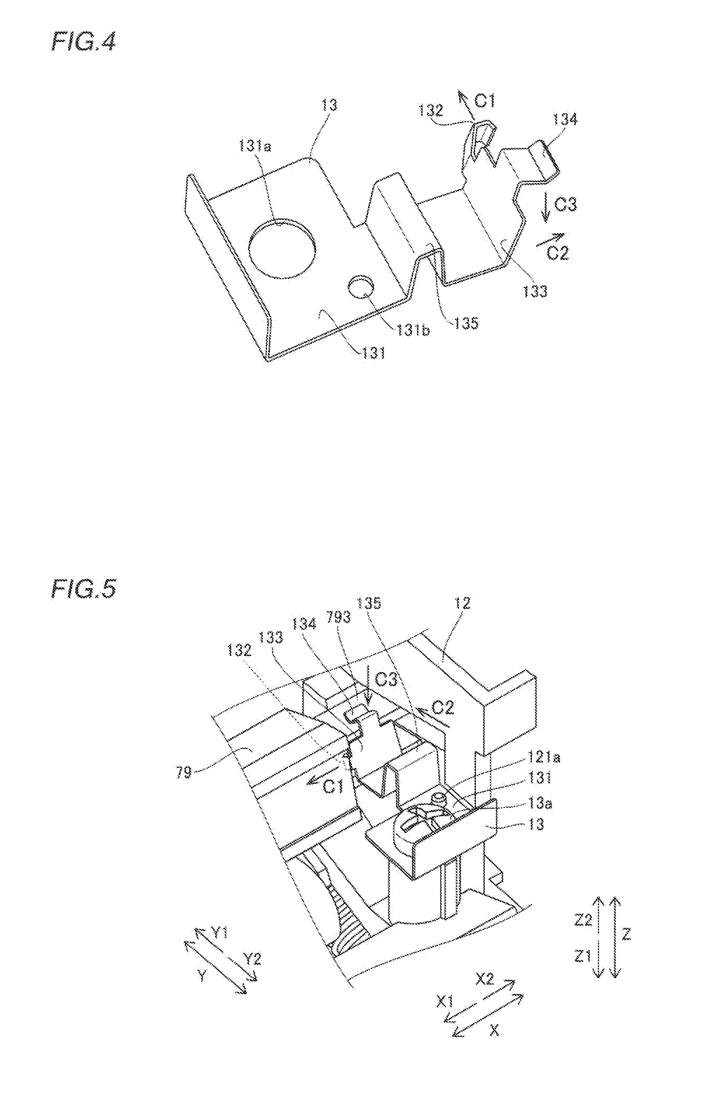

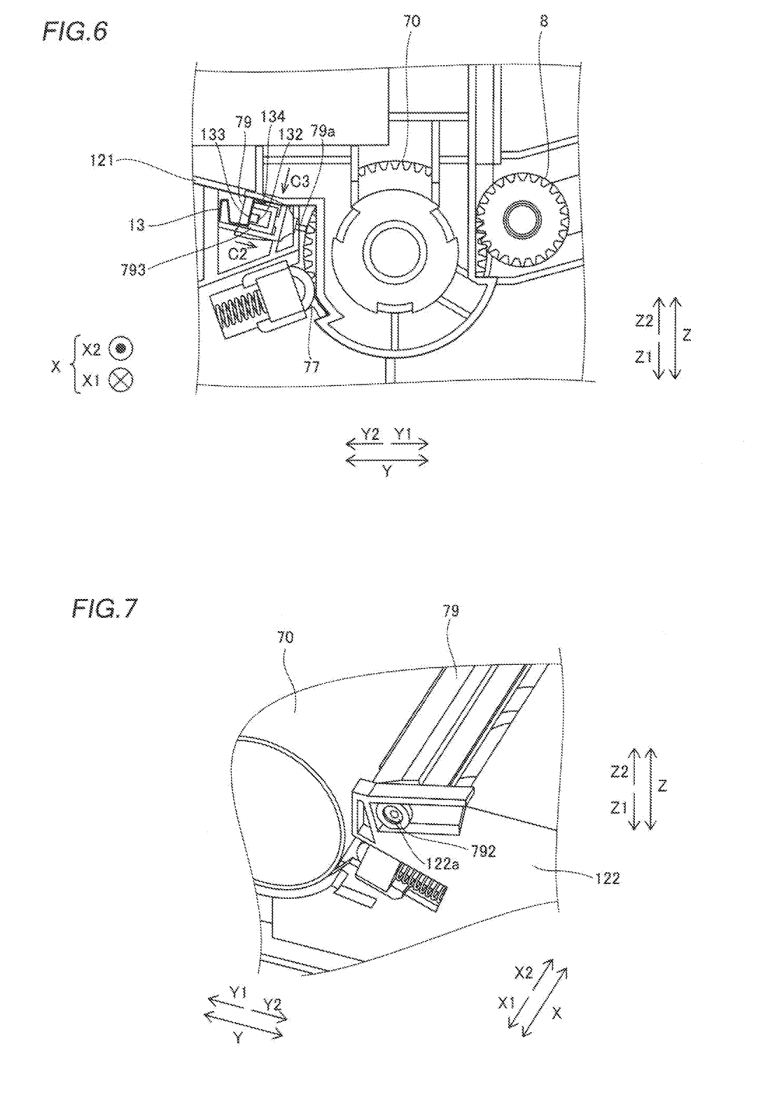

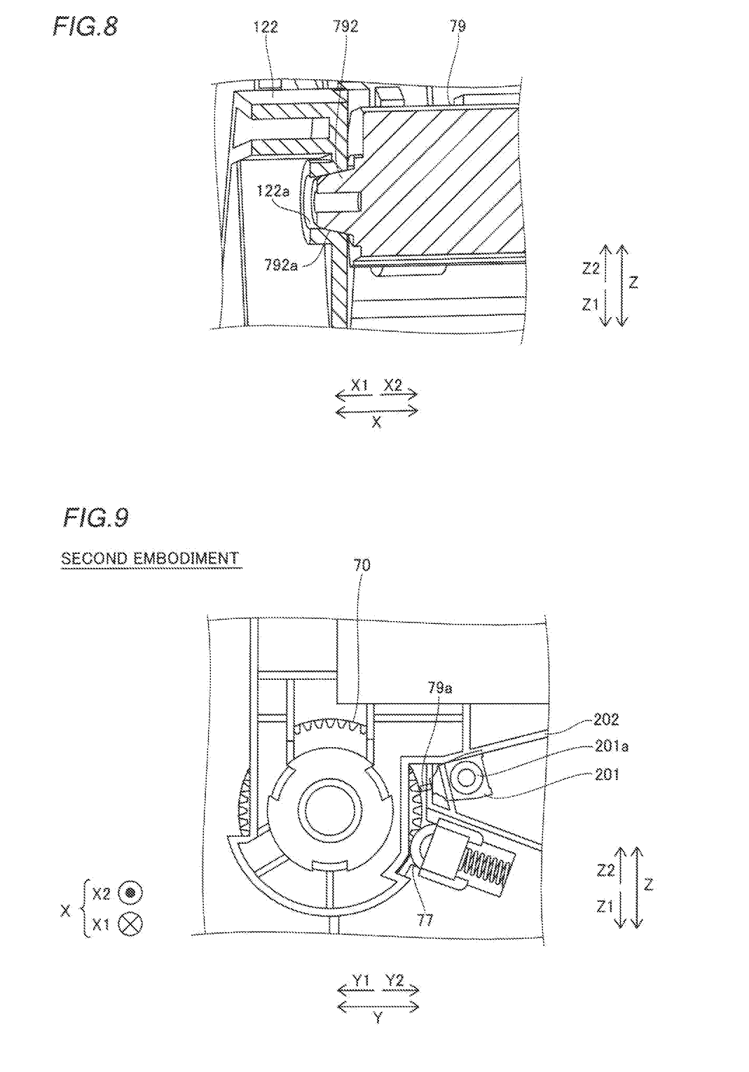

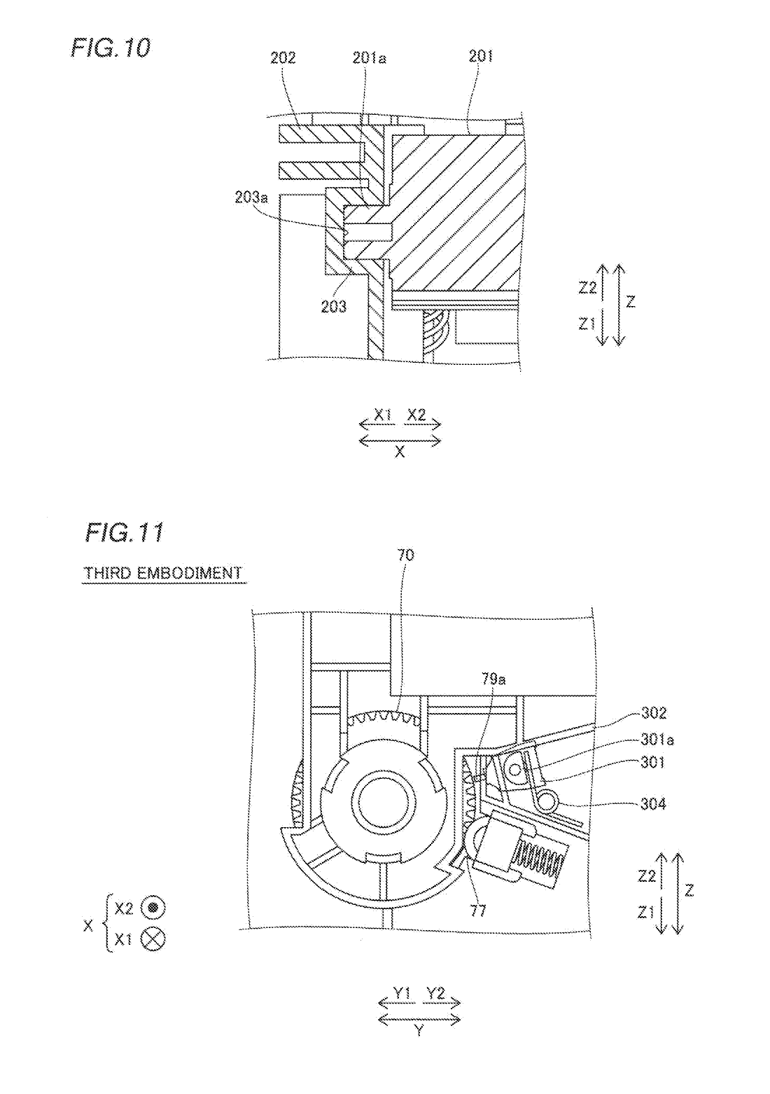

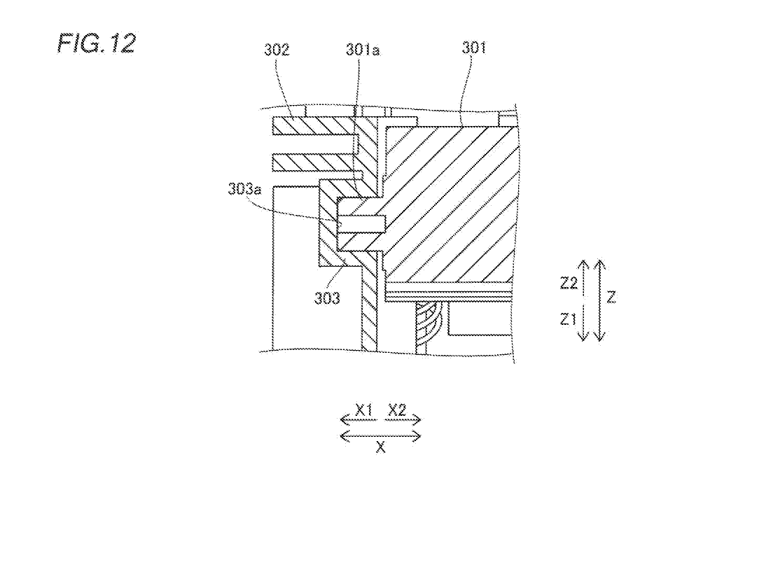

### BRIEF DESCRIPTION OF THE DRAWINGS

[FIG. 1] A schematic view showing the overall structure of a printer according to a first embodiment of the present invention.

[FIG. 2] A perspective view showing an LPH mounted on a housing portion of the printer according to the first embodiment of the present invention.

[FIG. 3] A perspective view showing the LPH of the printer according to the first embodiment of the present invention.

[FIG. 4] A perspective view showing a light source fixing member of the printer according to the first embodiment of the present invention.

[FIG. 5] A perspective view showing the mounting structure of an end of the LPH in a direction X2 of the printer according to the first embodiment of the present invention.

[FIG. 6] A side elevational view showing the mounting structure of the end of the LPH in the direction X2 of the printer according to the first embodiment of the present invention.

[FIG. 7] A perspective view showing the mounting structure of an end of the LPH in a direction X1 of the printer according to the first embodiment of the present invention.

[FIG. 8] A perspective sectional view showing the mounting structure of the end of the LPH in the direction X1 of the printer according to the first embodiment of the present invention.

[FIG. 9] A side elevational view showing the mounting structure of an end of an LPH in a direction X1 of a printer according to a second embodiment of the present invention.

[FIG. 10] A sectional view showing the mounting structure of the end of the LPH in the direction X1 of the printer according to the second embodiment of the present invention.

[FIG. 11] A side elevational view showing the mounting structure of an end of an LPH in a direction X1 of a printer according to a third embodiment of the present invention.

[FIG. 12] A sectional view showing the mounting structure of the end of the LPH in the direction X1 of the printer according to the third embodiment of the present invention.

### MODES FOR CARRYING OUT THE INVENTION

Embodiments embodying the present invention are hereinafter described on the basis of the drawings.

### First Embodiment

The structure of a printer 100 according to a first embodiment of the present invention is now described with reference to FIGS. 1 to 8.

The printer 100 according to the first embodiment of the present invention includes a paper feed tray 1 into which paper P is loaded to be fed, a take-up roller 2 configured to take up the paper P loaded into the paper feed tray 1 into the printer 100, a pair of transport rollers 3 configured to transport the paper P to a printing position, a feed roller 4 configured to send the paper P to the printing position, and a pair of paper discharge rollers 6 configured to discharge the paper P to a paper discharge tray 5, as shown in FIG. 1. The printer 100 also includes a developing device 7 configured to print an image on the paper P and a transfer roller 8 configured to transfer an image that the developing device 7 carries to the paper P. The laser printer 100 is an example of the “image forming apparatus” in the present invention.

The printer 100 further includes a fuser roller 9 configured to heat the paper P so as to fix the image and a pressing roller 10 configured to press the paper P to the fuser roller 9. In the printer 100, the paper P is transported through a transport path shown by arrow A. The printer 100 further includes a casing 11 that forms the outer shape of the printer 100 and a housing portion 12 arranged inside the casing 11, on which each component of the printer 100 can be mounted.

The developing device 7 includes a photoreceptor drum 70 mounted on the housing portion 12 to be rotatable using a direction X as a rotation axis, configured to perform printing by causing toner to adhere to the paper P, a developing roller 71 configured to supply the toner to the photoreceptor drum 70, a toner feed roller 72 configured to feed the toner to the developing roller 71, and a restricting roller 73, as shown in FIG. 1. All of the developing roller 71, the toner feed roller 72, and the restricting roller 73 are arranged in a toner carrying region 74. The photoreceptor drum 70 is an example of the “image carrier” in the present invention. The direction X is an example of the “first direction” in the present invention.

The developing device 7 also includes a toner supply passage 75 that supplies the toner to the toner carrying region 74 and a toner cartridge 76 that stores new toner. The developing device 7 further includes a charging roller 77 arranged to face the photoreceptor drum 70, configured to negatively charge a surface of the photoreceptor drum 70, a cleaning portion 78 configured to recover the toner moved from the photoreceptor drum 70 to a surface of the charging roller 77, and an LPH (LED print head) 79 configured to apply light to a photoreceptor drum 70. The photoreceptor drum 70, the charging roller 77, the cleaning portion 78, the LPH 79, and the transfer roller 8 are mounted on the housing portion 12. The LPH 79 is an example of the “light source portion” in the present invention.

The surface of the photoreceptor drum 70 is configured to be negatively charged by the charging roller 77. In the photoreceptor drum 70 during printing, the LPH 79 first applies light to a predetermined surface of the photoreceptor drum 70 along the rotational direction B of the photoreceptor drum 70, and negative charge is removed from a surface of a position subjected to the application of the light. Thus, an electrostatic latent image is formed on a region of the surface of the photoreceptor drum 70 from which the negative charge is removed. In the developing roller 71, on the other hand, the toner caused to adhere to the surface by the restricting roller 73 is frictionally charged to be negatively charged. Thereafter, the negatively charged toner supplied by the developing roller 71 adheres to the electrostatic latent image formed on the photoreceptor drum 70. Then, the negatively charged toner is moved from the photoreceptor drum 70 toward the positively charged transfer roller 8, whereby the toner is adsorbed (transferred) to the paper P arranged between the transfer roller 8 and the photoreceptor drum 70. Consequently, printing is performed on the paper P on the basis of the electrostatic latent image formed on the photoreceptor drum 70.

After the negative charge is removed from the surface of the photoreceptor drum 70, the charging roller 77 recovers toner remaining on the surface of the photoreceptor drum 70, and the outer peripheral surface of the photoreceptor drum 70 is uniformly negatively charged again. Then, the cleaning portion 78 recovers toner adhering to the surface of the charging roller 77.

The housing portion 12 includes side portions 121 and 122 and a body portion 123, as shown in FIG. 2. The side portion 121 forms a side surface in a direction X2. The side portion 122 forms a side surface in a direction X1. The photoreceptor drum 70, the charging roller 77 (see FIG. 1), the cleaning portion 78 (see FIG. 1), the LPH 79, and the transfer roller 8 are mounted on the housing portion 12 such that both ends in the direction X are supported by the side portions 121 and 122.

As shown in FIG. 3, the LPH 79 is arranged in the housing portion 12 to extend along the direction X. The LPH 79 is configured to apply light to the photoreceptor drum 70. Specifically, the LPH 79 includes a plurality of LEDs (light-emitting diodes) 79a arrayed along the direction X. In the LPH 79, a body portion 791 in which the LEDs 79a are arranged and a protrusion portion 792 arranged in an end in the direction X1, and a fixation portion 793 arranged in an end in the direction X2 are integrally provided. The LPH 79 is mounted on the housing portion 12 such that the protrusion portion 792 is mounted on the side portion 122 of the housing portion 12 in the direction X1 and the fixation portion 793 is mounted on the side portion 121 of the housing portion 12 in the direction X2. The protrusion portion 792 is an example of the “first engagement portion” in the present invention, and the LEDs 79a are examples of the “light source” in the present invention.

According to the first embodiment, the LPH 79 is fixed to the housing portion 12 by a light source fixing member 13 in the vicinity of the end in the direction X2, as shown in FIG. 5. The fixation portion 793 of the LPH 79 is urged in a direction C1, a direction C2, and a direction C3 by the light source fixing member 13 in a state where the LPH 79 is placed in the housing portion 12, whereby the LPH 79 is fixed to the housing portion 12. The direction C1, the direction C2, and the direction C3 are examples of the “first direction”, the “second direction”, and the “third direction” in the present invention, respectively.

As shown in FIG. 4, in the light source fixing member 13, a mounting portion 131, a first restriction portion 132 that restricts the movement of the LPH 79 in the direction C1 with respect to the housing portion 12, a second restriction portion 133 that restricts the movement of the LPH 79 in the direction C2 intersecting with the direction C1 with respect to the housing portion 12, and a third restriction portion 134 that restricts the movement of the LPH 79 in the direction C3 intersecting with each of the direction C1 and the direction C2 with respect to the housing portion 12 are integrally provided. The light source fixing member 13 includes a leaf spring. As shown in FIGS. 5 and 6, the direction C1 is the axis direction (direction X) of the photoreceptor drum 70. The direction C2 is the radial direction of the photoreceptor drum 70. The direction C3 is the circumferential direction of the photoreceptor drum 70. In other words, the direction C1, the direction C2, and the direction C3 substantially orthogonally intersect with each other.

The light source fixing member 13 is configured to urge the LPH 79 from the end in the direction X2 toward the end in the direction X1 in the direction C1 by the first restriction portion 132 and to urge the LPH 79 toward the photoreceptor drum 70 in the direction C2 by the second restriction portion 133. Specifically, the fixation portion 793 of the LPH 79 has a substantially U-shaped cross-section, as shown in FIGS. 3 and 6. The first restriction portion 132 of the light source fixing member 13 is configured to come into contact with an end surface of the body portion 791 of the LPH 79 in the direction X2 and urge the LPH 79 in the direction C1 inside the substantially U-shaped fixation portion 793. The second restriction portion 133 of the light source fixing member 13 is configured to come into contact with an end surface of the fixation portion 793 of the LPH 79 in a direction Y2 and urge the LPH 79 in the direction C2. In other words, the second restriction portion 133 is configured to come into contact with end surfaces of two sides of the substantially U-shaped fixation portion 793 closer to an opening and urge the LPH 79 in the direction C2. The third restriction portion 134 of the light source fixing member 13 is configured to come into contact with an outer end surface of the fixation portion 793 of the LPH 79 in a direction Z2 and urge the LPH 79 in the direction C3.

The light source fixing member 13 further includes a bent portion 135 that is bent in a substantially U-shape as viewed in the direction C1 and is deflectable in the direction C2. The light source fixing member 13 is fixed to the housing portion 12 by a fastening member 13a such as a screw. Specifically, the light source fixing member 13 includes a screw insertion hole 131a and a dowel hole (boss hole) 131b provided in the mounting portion 131, as shown in FIG. 4. As shown in FIG. 5, a dowel (boss) 121a of the housing portion 12 is inserted into the dowel hole (boss hole) 131b, and the light source fixing member 13 is fixed (screwed) to the housing portion 12 by the fastening member 13a through the screw insertion hole 131a. In other words, the position of the light source fixing member 13 to be fixed to the housing portion 12 is configured to be defined in a state where the dowel (boss) 121a is inserted into the dowel hole (boss hole) 131b.

According to the first embodiment, the protrusion portion 792 of the LPH 79 arranged in the end in the direction X1 engages with an engagement hole 122a provided in the side portion 122 of the housing portion 12, as shown in FIG. 7. Thus, the position of the LPH 79 is defined in the direction X. The engagement hole 122a is an example of the “second engagement portion” in the present invention. As shown in FIG. 8, the protrusion portion 792 includes a tapered portion 792a having a diameter reduced toward the end (in the direction X1), and the tapered portion 792a comes into contact with the engagement hole 122a to define the position of the LPH 79 in the direction X1 (direction C1). The protrusion portion 792 is hollow.

According to the first embodiment, the following effects can be obtained.

More specifically, according to the first embodiment, as hereinabove described, the printer 100 includes the light source fixing member 13 in which the first restriction portion 132 that restricts the movement of the LPH 79 in the direction C1 with respect to the housing portion 12, the second restriction portion 133 that restricts the movement of the LPH 79 in the direction C2 with respect to the housing portion 12, and the third restriction portion 134 that restricts the movement of the LPH 79 in the direction C3 with respect to the housing portion 12 are integrally provided, whereby the number of components configured to fix the LPH 79 that applies light to the photoreceptor drum 70 can be reduced as compared with the case where the first restriction portion that restricts the movement in the direction C1, the second restriction portion that restricts the movement in the direction C2, and the third restriction portion that restricts the movement in the direction C3 are provided separately. Furthermore, the number of assembly steps can be reduced as compared with the case where the first restriction portion, the second restriction portion, and the third restriction portion are sequentially mounted.

According to the first embodiment, as hereinabove described, the light source fixing member 13 is configured to urge the LPH 79 from the end in the direction X2 toward the end in the direction X1 in the direction C1 by the first restriction portion 132 and to urge the LPH 79 toward the photoreceptor drum 70 in the direction C2 by the second restriction portion 133. Thus, the position of the LPH 79 to be fixed can be reliably defined with respect to the photoreceptor drum 70 in the direction C1 (direction X), which is the rotation axis direction of the photoreceptor drum 70, and the position of the LPH 79 to be fixed can be reliably defined with respect to the photoreceptor drum 70 in the direction C2, which is a direction in which the photoreceptor drum 70 and the LPH 79 are away from each other.

According to the first embodiment, as hereinabove described, the protrusion portion 792 arranged in the end of the LPH 79 in the direction X1 engages with the engagement hole 122a of the housing portion 12 to defined the position of the LPH 79 in the direction C1 (direction X). Thus, after the protrusion portion 792 engages with the engagement hole 122a in the end of the LPH 79 in the direction X1 to define the position of the LPH 79 in the direction C1 (direction X), the movement of the LPH 79 in the direction C1, the direction C2, and the direction C3 is restricted in the end of the LPH 79 in the direction X2 such that the LPH 79 can be fixed to the housing portion 12.

According to the first embodiment, as hereinabove described, the tapered portion 792a of the protrusion portion 792 comes into contact with the engagement hole 122a to define the position of the LPH 79 in the direction C1 (direction X). Thus, the tapered portion 792a of the protrusion portion 792 can come into contact with and be fitted into the engagement hole 122a, and hence an engagement gap between the protrusion portion 792 and the engagement hole 122a can be eliminated. Thus, backlash can be eliminated.

According to the first embodiment, as hereinabove described, the LPH 79 is fixed to the housing portion 12 by the fastening member 13a. Thus, the light source fixing member 13 can be reliably fixed to the housing portion 12 by the fastening member 13a, and hence the LPH 79 can be easily fixed to the housing portion 12 through the light source fixing member 13.

According to the first embodiment, as hereinabove described, the light source fixing member 13 includes the leaf spring. Thus, the movement of the LPH 79 in the direction C1, the direction C2, and the direction C3 is restricted by the single leaf spring such that the LPH 79 can be easily fixed to the housing portion.

According to the first embodiment, as hereinabove described, the LPH 79 includes the plurality of LEDs 79a arrayed along the direction C1. Thus, using the LEDs 79a as the light source, the life of the LPH 79 can be extended, and energy consumed by the LPH 79 can be saved.

According to the first embodiment, as hereinabove described, the LPH 79 includes the fixation portion 793 arranged in one end in the direction C1, fixed to the housing portion 12 by the light source fixing member 13. Thus, the LPH 79 can be reliably fixed to the housing portion 12 by the fixation portion 793 and the light source fixing member 13.

According to the first embodiment, as hereinabove described, the body portion 791, the protrusion portion 792, and the fixation portion 793 are integrally provided. Thus, the number of components can be reduced as compared with the case where the body portion 791, the protrusion portion 792, and the fixation portion 793 are formed separately.

According to the first embodiment, as hereinabove described, the first restriction portion 132 of the light source fixing member 13 is configured to come into contact with the end surface of the body portion 791 in the direction X2 and urge the LPH 79 in the direction C1 inside the substantially U-shaped fixation portion 793. Thus, the first restriction portion 132 is inserted into the substantially U-shaped fixation portion 793 and urges an end of the body portion 791, and hence the first restriction portion 132 can urge the LPH 79 in the direction C1 without interfering with the second restriction portion 133 and the third restriction portion 134.

According to the first embodiment, as hereinabove described, the second restriction portion 133 of the light source fixing member 13 is configured to come into contact with the end surfaces of the two sides of the substantially U-shaped fixation portion 793 closer to the opening and urge the LPH 79 in the direction C2. Thus, the second restriction portion 133 can easily restrict the movement of the LPH 79 in the direction C2 with respect to the housing portion 12 by urging the end surfaces of the two sides of the substantially U-shaped fixation portion 793 closer to the opening in the direction C2.

According to the first embodiment, as hereinabove described, the third restriction portion 134 of the light source fixing member 13 is configured to come into contact with the substantially U-shaped fixation portion 793 from the outside and urge the LPH 79 in the direction C3. Thus, the third restriction portion 134 can easily restrict the movement of the LPH 79 in the direction C3 with respect to the housing portion 12 by urging the LPH 79 in the direction C3 from the outside of the substantially U-shaped fixation portion 793.

According to the first embodiment, as hereinabove described, the direction C1 is the axis direction of the photoreceptor drum 70, the direction C2 is the radial direction of the photoreceptor drum 70, and the direction C3 is the circumferential direction of the photoreceptor drum 70. Thus, the LPH 79 can be easily positioned in a predetermined location in the axis direction, the radial direction, and the circumferential direction of the photoreceptor drum 70 to be fixed to the housing portion 12.

According to the first embodiment, as hereinabove described, the light source fixing member 13 includes the bent portion 135 that is bent in the substantially U-shape as viewed in the direction C1 and is deflectable in the direction C2. Thus, the second restriction portion 133 can be urged in the direction C2 by restoring force resulting from the deflection of the bent portion 135, and hence the second restriction portion 133 can easily urge the LPH 79 in the direction C2.

According to the first embodiment, as hereinabove described, the protrusion portion 792 is fitted into and engages with the engagement hole 122a. Thus, the protrusion portion 792 is fitted into and engages with the engagement hole 122a in the end of the LPH 79 in the direction X1, which is the direction C1, to accurately define the position of the LPH 79 in the direction C1.

According to the first embodiment, as hereinabove described, the position of the light source fixing member 13 to be fixed to the housing portion 12 is configured to be defined in the state where the dowel (boss) 121a is inserted into the dowel hole (boss hole) 131b. Thus, the light source fixing member 13 can be fixed to the housing portion 12 after the position of the light source fixing member is accurately defined by the dowel (boss) 121a.

### Second Embodiment

A second embodiment is now described with reference to FIGS. 9 and 10. In this second embodiment, an example in which an end of a protrusion portion is brought into contact with a housing portion to define the position of an LPH in a direction X is described unlike the aforementioned first embodiment in which the tapered portion of the protrusion portion is brought into contact with the housing portion 12 to define the position of the LPH in the direction X.

In a printer 200 (see FIG. 1) according to the second embodiment of the present invention, a protrusion portion 201a of an LPH 201 arranged in an end in a direction X1 engages with an engagement hole 203 provided in a side portion 202 of a housing portion 12, as shown in FIGS. 9 and 10. Specifically, an end of the protrusion portion 201a comes into contact with a bottom portion 203a of the concave engagement hole 203 of the housing portion 12 to define the position of the LPH 201 in the direction X (direction C1). The protrusion portion 201a is hollow. The printer 200 is an example of the “image forming apparatus” in the present invention, and the LPH 201 is an example of the “light source portion” in the present invention. The protrusion portion 201a is an example of the “first engagement portion” in the present invention, and the engagement hole 203 is an example of the “second engagement portion” in the present invention.

The remaining structure of the second embodiment is similar to that of the aforementioned first embodiment.

According to the second embodiment, the following effects can be obtained.

More specifically, also in the structure according to the second embodiment, the printer 200 includes a light source fixing member 13 in which a first restriction portion 132 that restricts the movement of the LPH 201 in the direction C1 with respect to the housing portion 12, a second restriction portion 133 that restricts the movement of the LPH 201 in a direction C2 with respect to the housing portion 12, and a third restriction portion 134 that restricts the movement of the LPH 201 in a direction C3 with respect to the housing portion 12 are integrally provided, similarly to the aforementioned first embodiment, whereby the number of components can be reduced.

According to the second embodiment, as hereinabove described, the end of the protrusion portion 201a comes into contact with the bottom portion 203a of the concave engagement hole 203 of the housing portion 12 to define the position of the LPH 201 in the direction C1 (direction X). Thus, the end of the protrusion portion 201a comes into contact with the bottom portion 203a of the concave engagement hole 203, and hence the position of the LPH 201 in the direction C1 (direction X) can be accurately defined.

The remaining effects of the second embodiment are similar to those of the aforementioned first embodiment.

### Third Embodiment

A third embodiment is now described with reference to FIGS. 11 and 12. In this third embodiment, an example in which not only an end of an LPH in a direction X2 but also an end of the LPH in a direction X1 are urged toward a photoreceptor drum is described unlike each of the aforementioned first and second embodiments in which only the end of the LPH in the direction X2 is urged toward the photoreceptor drum.

In a printer 300 (see FIG. 1) according to the third embodiment of the present invention, a protrusion portion 301a of an LPH 301 arranged in an end in the direction X1 engages with an engagement hole 303 provided in a side portion 302 of a housing portion 12, as shown in FIGS. 11 and 12. Specifically, an end of the protrusion portion 301a comes into contact with a bottom portion 303a of the concave engagement hole 303 of the housing portion 12 to define the position of the LPH 301 in a direction X (direction C1). The protrusion portion 301a is hollow. The printer 300 is an example of the “image forming apparatus” in the present invention, and the LPH 301 is an example of the “light source portion” in the present invention. The protrusion portion 301a is an example of the “first engagement portion” in the present invention, and the engagement hole 303 is an example of the “second engagement portion” in the present invention.

According to the third embodiment, the printer 300 includes a spring 304 that is arranged closer to the end of the LPH 301 in the direction X1 and urges the LPH 301 toward a photoreceptor drum 70, as shown in FIG. 11. Specifically, the spring 304 is configured to come into contact with an end surface of the protrusion portion 301a in a direction Y2 and urge the LPH 301 toward the photoreceptor drum 70 (in a direction C2). The spring 304 is an example of the “urging portion” in the present invention.

The remaining structure of the third embodiment is similar to that of the aforementioned first embodiment.

According to the third embodiment, the following effects can be obtained.

More specifically, also in the structure according to the third embodiment, the printer 300 includes a light source fixing member 13 in which a first restriction portion 132 that restricts the movement of the LPH 301 in the direction C1 with respect to the housing portion 12, a second restriction portion 133 that restricts the movement of the LPH 301 in the direction C2 with respect to the housing portion 12, and a third restriction portion 134 that restricts the movement of the LPH 301 in a direction C3 with respect to the housing portion 12 are integrally provided, similarly to the aforementioned first embodiment, whereby the number of components can be reduced.

According to the third embodiment, as hereinabove described, the printer 300 is provided with the spring 304 that is arranged closer to the end of the LPH 301 in the direction X1 and urges the LPH 301 toward the photoreceptor drum 70. Thus, the movement of the LPH 301 in the direction C1, the direction C2, and the direction C3 is restricted in the end of the LPH 301 in the direction X2 while the LPH 301 is urged toward the photoreceptor drum 70 in the end of the LPH 301 in the direction X1, and the LPH 301 can be reliably fixed while the position of the LPH 301 is accurately defined with respect to the housing portion 12.

The remaining effects of the third embodiment are similar to those of the aforementioned first and second embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the example of applying the image forming apparatus according to the present invention to the printer has been shown in each of the aforementioned first to third embodiments, the present invention is not restricted to this. According to the present invention, the image forming apparatus may be applied to an apparatus such as a combined machine in which a scanner, a printer function, etc. are unified.

While the example of arranging the light source fixing member in the vicinity of one end of the LPH (light source portion) in the first direction (direction X) and fixing the LPH to the housing portion has been shown in each of the aforementioned first to third embodiments, the present invention is not restricted to this. According to the present invention, the light source fixing member may be arranged in the vicinity of both ends of the light source portion in the first direction, and the LPH may be fixed to the housing portion.

While the example in which the light source portion includes the plurality of LEDs (light-emitting diodes) has been shown in each of the aforementioned first to third embodiments, the present invention is not restricted to this. According to the present invention, the light source portion may include a light source other than the LEDs.

While the example in which the protrusion portion (first engagement portion) is integrally provided in the LPH (light source portion) has been shown in each of the aforementioned first to third embodiments, the present invention is not restricted to this. According to the present invention, the first engagement portion may be provided separately from the light source portion.

While the example in which the light source fixing member restricts the movement of the LPH (light source portion) in the direction C1 (first direction), the direction C2 (second direction), and the direction C3 (third direction) that substantially orthogonally intersect with each other has been shown in each of the aforementioned first to third embodiments, the present invention is not restricted to this. According to the present invention, the light source fixing member may restrict the movement of the light source portion in the first direction, the second direction, and the third direction that are slightly deviated from directions that orthogonally intersect with each other.

While the example in which the light source fixing member urges the LPH (light source portion) in the direction C1 (first direction), the direction C2 (second direction), and the direction C3 (third direction) has been shown in each of the aforementioned first to third embodiments, the present invention is not restricted to this. According to the present invention, the light source fixing member may restrict the movement of the light source portion without urging the light source portion in the first direction, the second direction, and the third direction.

While the example in which the light source fixing member includes the leaf spring has been shown in each of the aforementioned first to third embodiments, the present invention is not restricted to this. According to the present invention, the light source fixing member may include a member other than the leaf spring.

While the example in which the light source fixing member is fixed (screwed) to the housing portion by the screw has been shown in each of the aforementioned first to third embodiments, the present invention is not restricted to this. According to the present invention, the light source fixing member may be fixed to the housing portion by caulking, adhesive bonding, or the like, for example.

### DESCRIPTION OF REFERENCE NUMERALS

1 paper feed tray (paper supply portion)

2 take-up roller (paper supply portion)

3 transport roller (paper supply portion)

4 feed roller (paper supply portion)

12 housing portion

13 light source fixing member

13a fastening member

70 photoreceptor drum (image carrier)

71 developing roller (toner supply portion)

72 toner feed roller (toner supply portion)

73 restricting roller (toner supply portion)

74 toner carrying region (toner supply portion)

75 toner supply passage (toner supply portion)

76 toner cartridge (toner supply portion)

79, 201, 301 LPH (light source portion)

79a LED (light source)

100, 200, 300 printer (image forming apparatus)

121a boss

122a, 203, 303 engagement hole (second engagement portion)

131b boss hole

132 first restriction portion

133 second restriction portion

134 third restriction portion

135 bent portion

201a, 301a, 792 protrusion portion (first engagement portion)

203a, 303a bottom portion

304 spring (urging portion)

792a tapered portion

791 body portion

793 fixation portion

1. An image forming apparatus (100, 200, 300) comprising:
a housing portion (12);
an image carrier (70) mounted on the housing portion to be rotatable using a first direction as a rotation axis;
a light source portion (79, 201, 301) that is arranged to extend along the first direction and applies light to the image carrier; and
a light source fixing member (13) in which a first restriction portion (132) that restricts movement of the light source portion in the first direction with respect to the housing portion, a second restriction portion (133) that restricts movement of the light source portion in a second direction intersecting with the first direction with respect to the housing portion, and a third restriction portion (134) that restricts movement of the light source portion in a third direction intersecting with each of the first direction and the second direction with respect to the housing portion are integrally provided, that fixes the light source portion to the housing portion in a vicinity of at least one end of the light source portion in the first direction.

2. The image forming apparatus according to claim 1, wherein
the light source fixing member urges the light source portion from one end side toward the other end side in the first direction by the first restriction portion and urges the light source portion toward the image carrier in the second direction by the second restriction portion.

3. The image forming apparatus according to claim 1, wherein
the first direction, the second direction, and the third direction substantially orthogonally intersect with each other.

4. The image forming apparatus according to claim 1, further comprising a first engagement portion (201a, 301a, 792) arranged on the other end side of the light source portion in the first direction, wherein
the first engagement portion engages with a second engagement portion of the housing portion to define a position of the light source portion in the first direction.

5. The image forming apparatus according to claim 4, wherein
the first engagement portion includes a tapered portion (792a) having a diameter reduced toward an end, and the tapered portion comes into contact with the second engagement portion to define the position of the light source portion in the first direction.

6. The image forming apparatus according to claim 4, wherein
an end of the first engagement portion comes into contact with a bottom portion (203a, 303a) of the second engagement portion (122a, 203, 303), which is concave, of the housing portion to define the position of the light source portion in the first direction.

7. The image forming apparatus according to claim 4, further comprising an urging portion (304) that is arranged on the other end side of the light source portion in the first direction and urges the light source portion toward the image carrier.

8. The image forming apparatus according to claim 1, wherein
the light source fixing member is fixed to the housing portion by a fastening member (13a).

9. The image forming apparatus according to claim 1, wherein
the light source fixing member includes a leaf spring.

10. The image forming apparatus according to claim 1, wherein
the light source portion includes a plurality of LEDs (79a) arrayed along the first direction.

11. The image forming apparatus according to claim 1, wherein
the light source portion includes a fixation portion (793) arranged in the one end in the first direction, fixed to the housing portion by the light source fixing member.

12. The image forming apparatus according to claim 11, wherein
the light source portion further includes a body portion (791) in which a light source (79a) is arranged and a first engagement portion (201a, 301a, 792) that is arranged on the other end side of the light source portion and defines a position of the light source portion in the first direction, and
the body portion, the first engagement portion, and the fixation portion are integrally provided.

13. The image forming apparatus according to claim 12, wherein
the fixation portion has a substantially U-shaped cross-section, and
the first restriction portion of the light source fixing member comes into contact with one end surface of the body portion and urges the light source portion in the first direction inside the fixation portion, which is substantially U-shaped.

14. The image forming apparatus according to claim 13, wherein
the second restriction portion of the light source fixing member comes into contact with end surfaces of two sides of the fixation portion, which is substantially U-shaped, closer to an opening and urges the light source portion in the second direction.

15. The image forming apparatus according to claim 13, wherein
the third restriction portion of the light source fixing member comes into contact with the fixation portion, which is substantially U-shaped, from an outside and urges the light source portion in the third direction.

16. The image forming apparatus according to claim 1, wherein
the first direction is an axis direction of the image carrier,
the second direction is a radial direction of the image carrier, and
the third direction is a circumferential direction of the image carrier.

17. The image forming apparatus according to claim 1, wherein
the light source fixing member further includes a bent portion (135) that is bent in a substantially U-shape as viewed in the first direction and is deflectable in the second direction.

18. The image forming apparatus according to claim 4, wherein
the first engagement portion includes a protrusion portion (201a, 301a, 792) that protrudes to the other end side in the first direction,
the second engagement portion includes a concave engagement hole (122a, 203, 303), and
the protrusion portion of the first engagement portion is fitted into and engages with the engagement hole of the second engagement portion.

19. The image forming apparatus according to claim 1, wherein
the light source fixing member is provided with a boss hole (131b), and a position of the light source fixing member to be fixed to the housing portion is defined in a state where a boss (121a) is inserted into the boss hole.

20. The image forming apparatus according to claim 1, further comprising:
a paper supply portion (1, 2, 3, 4) that supplies paper to the image carrier; and
a toner supply portion (71, 72, 73, 74, 75, 76) that supplies toner to the image carrier.
